(19) United States
(12) Patent Application Publication
(10) Pub. No.: US 2006/0188053 A1
(43) Pub. Date: Aug. 24, 2006

(54) Method and device for loading nuclear fuel pellets

(76) Inventors: Alain Vandergheynst, Dour (BE); Louis Aerts, Mol (BE); Leon Mertens, Lasne (BE)

Correspondence Address: SUGHRUE MION, PLLC, 2100 PENNSYLVANIA AVENUE, N.W., SUITE 800, WASHINGTON, DC, 20037, US

(21) Appl. No.: 10/540,030

(22) PCT Filed: Dec. 24, 2002
(86) PCT No.: PCT/BE02/00202

§ 371 Date: Jun. 22, 2005

(51) Int. Cl. G21C 19/00

(52) U.S. Cl. 376/260

(57) ABSTRACT

Method and device for loading nuclear fuel pellets into a cladding provided with its first plug, by means of an introduction element and using limited forces.

### SCOPE OF THE INVENTION

The present invention relates to a method and a device for loading nuclear fuel pellets in successive columns into a metal cladding previously provided with a first plug at one of its two ends.

As a reminder, a nuclear fuel rod generally consists of a metal cladding made from a zirconium alloy or stainless steel, fuel pellets, most often of a uranium oxide or uranium/plutonium oxide, a retaining spring and two welded end plugs. The cladding and welded plugs assembly provides sealing of the rod and containment of the nuclear materials with regard to the external environment. These rods are filled with an inert gas (most often helium) in order to provide transfer of the heat produced by the pellets to the cladding, and can be pressurised or not. The gap between pellets and cladding is limited, typically of the order of 150-200 μm for light-water reactors.

In certain cases, other structural components such as separator tubes, isolation pellets, “getters”, etc. can be loaded at the head or foot of the rod.

The management policy of electricity producers and nuclear fuel designers aims to strive for increasingly greater burn-up rates at unloading time and is causing the manufacturers to produce in particular MOX (Mixed Oxide, a mixture of uranium oxide and plutonium oxide) fuel, with increasingly higher fissile plutonium contents, and with plutoniums of civil origin having an increasingly degraded isotopic composition. A reduction in the ²³⁹Pu fraction and an increase in the ²³⁸Pu and ²⁴¹Pu fractions are observed. This degradation in isotopic composition increases the specific activity of these plutoniums (in particular the α, β, γ, neutron activity) and necessitates increased protection for personnel and equipment.

In particular, in order to protect personnel from ionising radiation and radioactive dust, the manufacture of MOX fuel rods typically requires that the loading operations take place in containment enclosures which are sealed (for example of the glove box type) and shielded. It follows that, for these reasons and in order to increase industrial productivity, a great number of operations, if not all, are performed in a mechanised and/or automated manner with a minimum amount of direct human intervention.

Consequently it is important that the method for loading the pellets can

be integrated into these automated operations; and

present the pellets accurately at the open end of the cladding and in particular overcome the unavoidable positioning errors of pellet feeding devices.

It is also important that the loading method is the least sensitive possible to blockages caused by chips or dust liable to be carried along by the pellets themselves and/or be produced during the loading operations themselves.

For the same reasons, the loading method must operate without excessive or unnecessary force on the pellets, which would risk producing additional chips or causing damage to the pellets, harmful to the quality of the rods and their behaviour in the reactor in particular, either the pellets being excessively damaged, or these chips creating unacceptable spaces gaps between pellets.

For the safety of manufacturing plant personnel, safety of transport and the safety of the reactors (contamination of the primary circuit), the designers and producers of fuel, MOX in particular, limit, to very low accepted values, the fixed and transferable contamination of the external surface of the rods loaded with pellets.

It is therefore also important that the method for loading pellets into the cladding aims to limit the cladding parts exposed to contamination and the magnitude of this contamination. In particular, the loading method must be designed to avoid causing an incrustation of contamination in the cladding and must aim to avoid decontamination operations by liquid means, owing to the increased risk of criticality and the production of liquid effluents.

### PRIOR ART

Striving for the objectives described above (automation and low sensitivity to blockages, production of non-contaminated rods, etc) can lead to particular technological options for both the upstream operations and the loading operations proper. There can be cited, for example, control of the accumulation of dust on the pellets before loading: by wet or dry grinding, by removal of dust from the pellets by mechanical means or by laser, by limiting the fraction of recycled discards, by gentle handling of the pellets, which contribute towards lessening the frequency of blockages and facilitate controlling the contamination of the rods.

Various existing devices and methods connected with the field of the present invention are cited in the documents summarised below:

use of a centring device/process for introduction of the pellets into the cladding, in the absence of particular containment devices (of the glove box type):
fixed centring of cylindrical/truncated cone shape (U.S. Pat. No. 4,980,119, U.S. Pat. No. 4,748,798, U.S. Pat. No. 5,251,244);
triple centring (one fixed+two intermediate) of circular cross-section (U.S. Pat. No. 3,940,908);
fixed V-shaped centring (U.S. Pat. No. 3,907,123);
fixed centring with polygonal or square cross-section (U.S. Pat. No. 4,942,014);

use of a centring device/process for introduction of the pellets into the cladding, mounted in a containment enclosure (of the glove box type):
truncated cone-shaped fixed centring mounted at the centre of the enclosure (U.S. Pat. No. 3,925,965);
centring mounted at the limit of the two areas, active and inactive, of the containment enclosure, the active area being reserved for loading of the pellets (WO 98/26428).

It should be noted that the devices and methods known to the inventors and mentioned above do not meet the objectives stated above:

either these devices are sensitive to the dust and chips conveyed by the pellets in columns and/or to those generated specifically during the operation of loading into the cladding, this sensitivity resulting in mechanical blockages, generating machine stoppages, operator interventions in containment enclosures, risks of contamination of the operators, of the workshops and even sometimes of the enclosure compartments, which ought to remain only slightly or non-contaminated;

or these devices for loading the pellets do not allow the manufacture of plutonium-based rods conforming to their non-contamination specification, when the plutonium content of the pellets and the alpha activity of the plutonium are high, even at the cost of an additional liquid decontamination operation;

or these devices do not contribute towards trapping the chips and in so doing contribute towards increasing the frequency of rods discarded for excessive spaces between successive pellets.

### PRESENTATION OF THE INVENTION

The aim of the present invention is to remedy the drawbacks cited above, and others known to persons skilled in the art, and to that end proposes a method which has a favourable influence on the rod manufacturing operations as well as on the quality of the manufactured products, by organising in particular a particular guidance of the pellets all the way into the cladding without them being able to touch the open end of the cladding and advantageously without unnecessarily mechanically stressing said pellets.

To that end, according to the invention, the following are performed:

correction of off-centrings between a support and the open end of the cladding, and alignment of the axis of the pellets with the axis of the cladding, by means of a channel, the bottom of which has a V-shaped profile in a continuous ramp and intersecting with a cylindrical output with the diameter of the pellets;

centring of the cladding in a chamber centred on the cylindrical part of the channel;

masking of the open end of the cladding from the pellet in the process of being loaded;

trapping and/or collection and/or forcing back of dust and chips, via the free sections between pellets and walls of the channel, by gravity deposition and optionally by additional blowing and/or suction.

These provisions of the invention advantageously simultaneously solve the problems of jamming of the pellets during their loading into the cladding, and the problems of introduction of chips into this same cladding and formation of gaps between pellets which are unacceptable for the finished rod.

According to one embodiment of the invention, loading of the pellets into the cladding is provided in columns which are introduced therein successively, so that the last pellet of each column is driven into the cladding to a depth equal to at least the length of the next column to be loaded into the same cladding.

This provision is advantageous on account of the fact that, until it is completely in the cladding, each column is subject to only a moderate force and said force increases significantly when said column comes into contact with the preceding one or ones, only when it is already inside the cladding and therefore well guided.

This provision, like the following two, contributes towards using reduced forces on the pellets:

limitation of the pushing forces during loading;

loading of the pellets into a cladding under vacuum or under helium.

The present invention also relates to a device for presentation, centring and alignment of the pellets during loading into the cladding, in particular for implementation of the method according to the invention.

According to the invention, the device:

consists of a fixed metal component with a channel passing through it, the dimensions of the input of which are chosen for accepting an off-centring of the pellets in relation to the axis of the cladding, and the bottom of which has a V-shaped profile in a continuous ramp and intersecting with a cylindrical output with the diameter of the pellets, and provided with a cylindrical chamber with the diameter of the cladding and centred on the cylindrical output of the channel;

has dimensions and tolerances adapted to the dimensions of said pellets and cladding, and such that the diameter of the cylindrical part of the channel is smaller than the internal diameter of the cladding, for the purposes of masking the end of the cladding from the pellets; and

optionally has longitudinal and/or transverse clearances and nozzles for blowing a gas in a direction opposite to the direction of loading and/or sucking up the dust and chips.

### ADVANTAGES

Amongst other advantages provided by the invention, the following may be cited:

loading of any type of nuclear fuel in pellet form, even with a tight cladding/pellets gap and in particular the loading of pellets with a high plutonium content;

different implementation possibilities: from completely manual processes up to fully automatic processes;

loading of dust-covered pellets with no special precautions;

absence of incrustation of contamination in and in the immediate vicinity of the open end face of the cladding;

limitation of the contamination during the operations of loading contaminated pellets, in particular MOX pellets, leading to limiting the operations on the rods solely to cleaning by rubbing the open end area of the rod and measurement of no transferable contamination at the output by mechanical rubbing;

absence of damage to the pellets by limitation and control of the loading force;

absence of rods discarded as a result of the presence of unacceptable inter-pellet gaps, inclusions in the circumferential welding between plug and cladding, contamination outside the specifications, etc.;

limited production of effluents and general operating economy.

Other details and particular features of the invention will emerge from the other claims and from the description of the schematic drawings, at undefined scales, which accompany the present specification and which illustrate, by way of non-limitative examples, the method and particular embodiments of the device according to the invention.

### DESCRIPTION OF THE FIGURES

FIG. 1 shows in axial section one embodiment of a fuel rod, the cladding of which can be loaded with pellets by implementing the invention.

FIG. 2A shows in a perspective view one embodiment of a fuel rod loading device of the invention.

FIG. 2B shows example embodiments of longitudinal and transverse clearances and gas nozzles G.

FIGS. 3A to 3F show in a plan view the different steps of a sequence of loading successive columns of pellets into the cladding, for implementation of the invention. FIG. 3A shows in addition a mechanism for limiting the pushing forces.

In the different figures, the same reference notations designate identical or similar elements.

### DESCRIPTION OF THE INVENTION

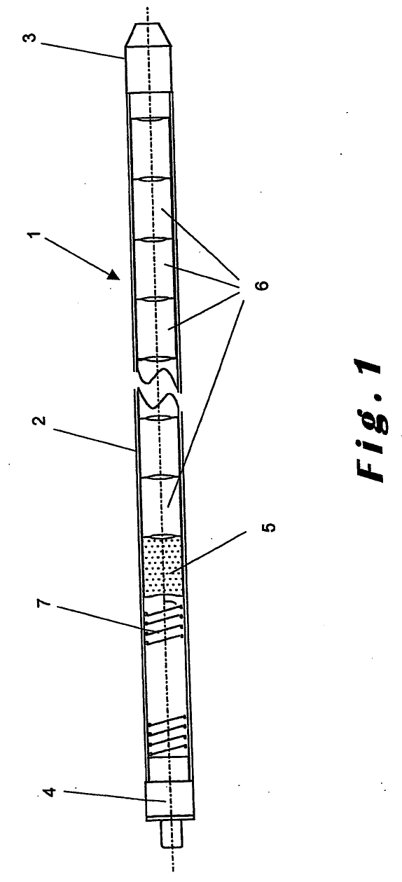

A rod 1 (FIG. 1) to which the invention relates can comprise, as already mentioned and as is known, a cladding 2 capped at one end by a first plug 3 and at the other end by a second plug 4. Between these plugs 3 and 4 there can be enclosed in the cladding 2 pellets 6, a spring 7 and structural components, like one or more separator elements 5.

The device and the method for loading pellets 6 into an aforementioned cladding 2, the object of the invention, are explained jointly in the present description on account of their complete mutual interweaving.

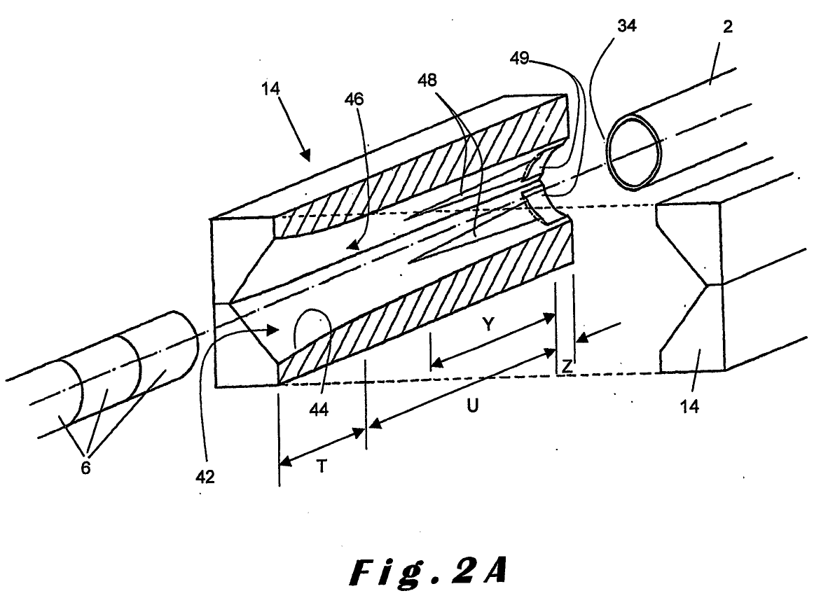

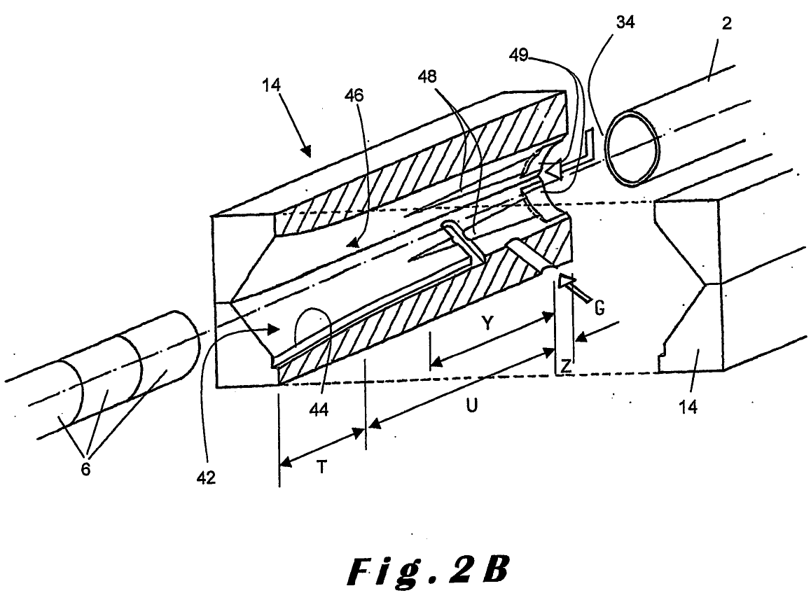

The method of the invention consists, in a cladding 2 previously provided with a first plug 3 at one of its two ends, of (FIG. 2):

presenting, centring and aligning the pellets 6 in columns 12 at the open end 34 of the cladding 2, position-wise and orientation-wise in order to avoid mechanical jamming;

eliminating from the column 12 of pellets 6 the dust and chips conveyed by and/or adhering to the pellets loaded, and/or generated by the presentation, centring and alignment operations.

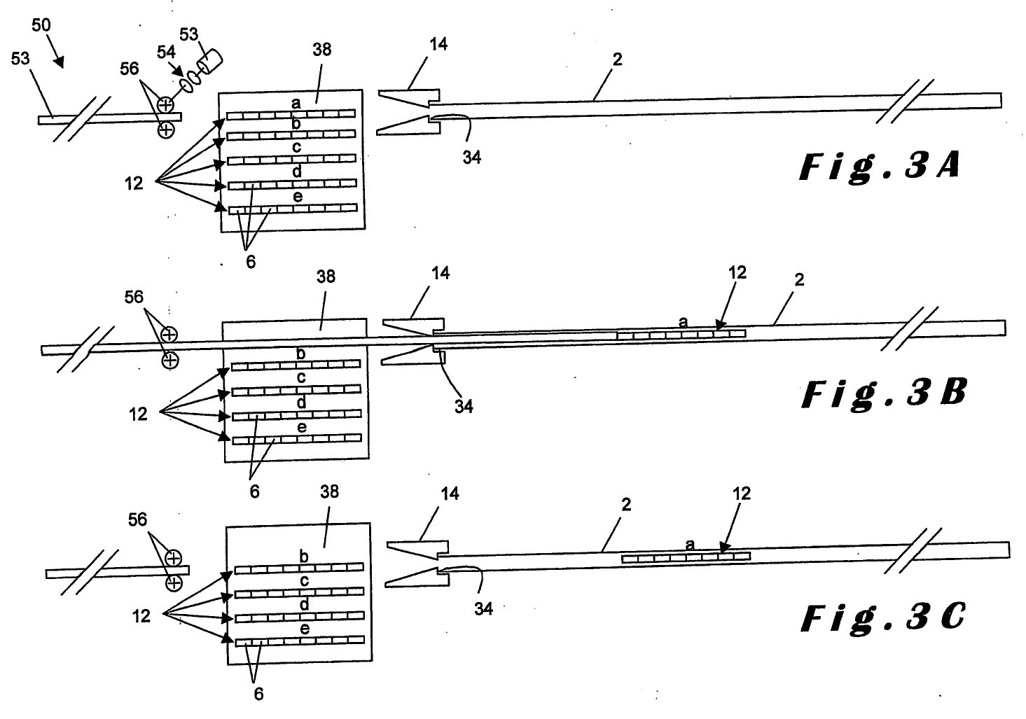

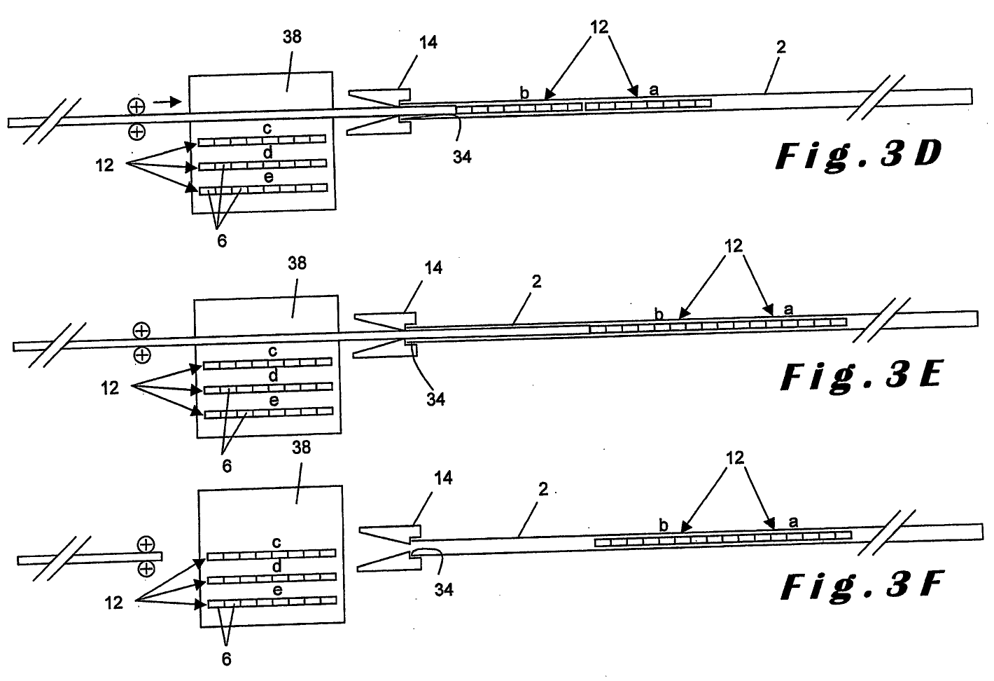

According to the invention, off-centrings between the support 38 and the open end 34 of the cladding 2 are corrected and the axis of the pellets 6 is aligned with the axis of the cladding 2 (FIGS. 2 and 3). To that end, the pellets 6 are guided, with a view to their alignment and centring, by means of a channel 42, the bottom of which has a V-shaped profile in a continuous ramp (T+U) and intersecting with a cylindrical output (Y) 48 with the diameter of the pellets 6, as described in detail below. The cladding 2 is centred in a chamber (Z) 49 centred on the cylindrical part (Y) 48 of said channel 42. Simultaneously, the open end 34 of the cladding 2 is masked from each pellet 6 in the process of being loaded in order to avoid massive contamination of the part of the cladding 2 close to its open end 34 and additional mechanical blockages and interference. This masking also avoids an incrustation of contamination occurring on the open end face 34.

Aerosols, dust and chips are trapped and/or collected and/or forced back, via free sections between pellets 6 and walls of the channel 42 and/or clearances, by gravity deposition and optionally by additional blowing and/or suction. This dust and these chips, which are either conveyed by said pellets 6 in the process of being loaded, or produced during the loading operation itself, might otherwise lead to jamming of the pellets 6 during their introduction into the cladding 2 or to discarded rods, in the event of their introduction into the cladding.

As shown by FIGS. 3B, 3E, the pellets 6 of a column 12 are advantageously driven into the cladding 2 to a depth of introduction of the last pellet 6 of this column 12 in the cladding 2 equal to at least the length of the next column 12 to be loaded into the same cladding 2. Thus, FIG. 3B shows the column 12a in its driven-in position, leaving a free space for receiving the column 12b in accordance with FIGS. 3D, 3E. As indicated above, until its complete introduction into the cladding, the pushing force on a column is limited solely to the force for pushing said column.

Loading of said pellets 6 in successive columns 12 into said cladding 2 is performed preferably by limiting the maximum pushing forces on the columns 12 during said loading, according to the depth of introduction and the order N (N going from “a” to “e” by way of example in FIG. 3) of the column 12 in the process of being loaded into the same cladding 2. Thus, the pushing is regulated so that it has a certain single maximum level for conveying the successive columns 12a-e as far as into the cladding 2 (FIG. 3D); the pushing is also regulated for moving the train of columns at another maximum level which is variable according to the number of columns already loaded.

Loading of the pellets into a cladding 2 under vacuum from an enclosure itself under vacuum notably reduces the forces used, as well as the contamination generated by the expulsion of any gas contained in the cladding by the pellets which are loaded therein. This loading under vacuum also makes it possible to avoid having to subsequently evacuate or having to rinse out the cladding 2 loaded with pellets 6, for the purposes of replacing the gas present with an inert gas, during the operations for fitting the plug 4 and welding.

Direct loading under helium provides comparable advantages owing in particular to its low dynamic viscosity.

These provisions make it possible to limit the forces applied to the pellets 6 and to avoid damaging them.

The device of the invention, for the presentation, centring and alignment of pellets 6 with a view to their loading into a cladding 2, is intended in particular for the implementation of the method of the invention, described above.

This so-called loading device comprises a fixed guidance element 14 consisting of a metal component which has a channel 42 passing through it, the dimensions of the input end (T) 44 of which are chosen for accepting an off-centring of the pellets 6 in relation to the axis of the cladding 2, and the bottom of which has a V-shaped profile in a continuous ramp (T+U) and intersecting with a cylindrical output (Y) 48 with the diameter of the pellets 6, and which is provided with a cylindrical chamber (Z) 49 with the external diameter of the cladding 2 and which is introduced therein in order to be positioned and centred thereby with respect to the cylindrical output (Y) 48 of the channel 42. This guidance element 14 has dimensions and tolerances adapted to the dimensions of said pellets 6 and cladding 2, and such that the diameter of the cylindrical part (Y) 48 of the channel 42 is smaller than the internal diameter of the cladding 2, for the purposes of masking the transverse face of the end of the cladding 2 from the pellets 6. This guidance element 14 can in addition have longitudinal and/or transverse clearances and nozzles G for blowing a gas in a direction opposite to the direction of loading and/or sucking up the dust and chips.

For conveying them to the guidance element 14, the pellets 6 are most often presented in columns 12 on a fixed V or on a plate 38 with V-shaped grooves and movable transversely with respect to the cladding 2, as depicted in FIG. 3.

In general, the V-shaped profile of the channel 42 has successively a square input on its tip (T) 44 and a section with a square cross-section on its tip (U) 46 continuously reducing in transverse cross-section.

The square input on its tip 44 permits large lateral and vertical gaps for the pellets (up to 1 to 2 mm) for the purposes of accepting misalignments of many origins (for example, vertical and horizontal misalignments of the Vs of the grooved plate 38 presenting the columns 12 of pellets).

The section with square cross-section on its tip (U) 46 has, in transverse cross-section, continuously decreasing dimensions in order to progressively centre and align the pellets 6 with respect to the cladding 2. Various reduction laws can be implemented with modern numerical control machines, for example from a linear reduction leading to a truncated pyramid, to a non-linear, for example quadratic, reduction as depicted in FIG. 2, making it possible to correct large misalignments over short lengths by means of changes in slope of a curved path.

The cylindrical output (Y) 48 has a diameter DY slightly larger than the diameter Dp of the pellets 6 (for example DY=Dpₘₐₓ+0.02 mm).

The cylindrical chamber (Z) 49 has a diameter DZ slightly larger than the diameter Dc of the cladding 2 (DZₙₒₘ=Dcₘₐₓ+0.01 mm, for example). The cylindrical output (Y) 48 and cylindrical chamber (Z) 49 have a diametral tolerance of −0/+0.01 mm and a satisfactory mutual concentricity (for example better than 0.01 mm), according to the available gaps between pellets 6 and cladding 2.

Longitudinal and/or transverse grooves or clearances can also be machined in the component 14 in order to contribute towards trapping the dust and chips.

The changes in direction of the pellets 6, from the feed table 38 up to the cylindrical output (Y) 48 of the guidance element 14, cause slight offsets between the pellets 6, which allows any chips to leave the column 12 of pellets and fall to the bottom of the V-shaped channel (T+U) 42.

The device of the invention can also comprise (FIG. 3), for the above-mentioned loading of the pellets 6, a means 50 of driving said pellets, comprising a long pushing device 53 with sensitive drive, with axial movement caused by a set of rollers 56 equipped with a force limiting device 54 with low inertia and driven by a motor 52, the force of which is limited according to the depth of introduction and the order N of the column 12 of pellets in the process of being loaded into one and the same cladding 2.

The pushing device 53 itself consists of a hollow rod 53 of low mass and adapted length so that the depth of introduction of the last pellet 6 of a column 12 loaded into the cladding 2 is equal to at least the length of the next column 12 to be loaded into the same cladding 2.

During loading of the columns 12 of pellets, it is important in fact to limit the forces to be used with the aim of

avoiding the transverse forces of the pellets 6 on the walls of the guidance element 14 and secondarily on the internal wall of the cladding 2. The pellets 6 of a column under axial pressure have a tendency to become misaligned as a function of the lack of perpendicularity of their radial faces and the gaps available in the guidance element 14 and the cladding 6. These forces are harmful when the pellets 6 cross the successive mechanical transitions (from the grooved plate 38 into the guidance element 14, from the guidance element 14 into the cladding 2) and increase the reactive frictional forces;

avoiding the production of additional chips and dust during loading, through excessive local pressure on the edges of the pellets 6 in contact by their end faces.

In order to limit the above-mentioned loading force, three methods can be used separately or in combination:

loading the pellets 6 under vacuum or under a gas with low dynamic viscosity (for example helium) in order to limit the back pressure in the cladding 2 during driving in of the columns 12 of pellets. It should be noted that the free volume between the first pellet 6 introduced and the closed end of the cladding 2 decreases progressively with the loading of the pellets 6 and can be reduced to zero at the end of loading in certain rod designs. Moreover, in the case of loading under gas, the differential pressure of the gas which is discharged through the gap between the pellets 6 and the cladding 2 increases at the same time with the lengthening of the total column of introduced pellets 6. The consequence of these two effects, decreasing free volume and increasing differential pressure is for example that, for the same loading speed, the back pressure increases significantly at the end of loading of the pellets 6 into said cladding 2;

driving in the columns of pellets 6 in the process of being loaded (FIG. 3) into the cladding 2, by a free depth equal to at least the length of the elementary columns 12 (FIG. 3B). In this way, the first pellet of a column N, upon its loading into the cladding, comes into contact with the last pellet of the column (N−1) (FIG. 3D) already loaded, and pushes the train of (N−1) columns already loaded, only when the last pellet of the column N is already inside the cladding (FIG. 3E). Therefore, the transverse forces developed by the pellets 6 on the cladding 2 are minimised and of limited harm on account of the excellent mechanical guidance provided by the cladding 2;

using a pellet-pushing device with sensitive drive, namely one which aims to limit in a general way the forces which it can develop on the column 12 of pellets to solely the forces necessary. As explained above, these required forces increase depending on whether one column in isolation or a train of columns is being pushed and increase as a greater number of elementary columns constitute the train of pellets loaded. These forces are for example limited electronically by controlling the electrical supply of a DC motor or servomotor 52, according to the order N of the column loaded and the depth to which the pushing device is driven in. Finally, in view of the industrial loading speeds being high, the effects of inertia are limited by using a pellet-pushing device 53 with a hollow rod and a magnetic powder torque limiter with slippage 54.

In general, the structural elements, other than the retaining spring 7 and the second end plug 4 and such as isolation pellets, covering pellets, “getters”, separator elements, braces, etc. are loaded at the same time as the fuel pellets, by means of the same method and device of the invention.

Reduction of the pushing speed for the train of columns of pellets can advantageously be implemented for the last column or columns loaded.

It should also be noted that the loading device of the invention can be used for direct introduction of the pellets into the cladding, and for centring and alignment thereof in any intermediate device provided before the cladding.

### EMBODIMENT

One embodiment implemented by the inventor will be found below:

loading of MOX pellets for light-water reactors of various diameters (7-12 mm), containing manufacturing discards and ground when dry, disposed on a grooved plate moved transversely step by step, in 450 mm columns and at introduction speeds of 100-150 mm/sec;

loading device installed in glove box under helium;

centring device with channel of truncated pyramid shape disposed on its tip and with cylindrical output;

various nozzles for blowing and forcing back aerosols and dust;

long and sensitive pushing device.

The inventors have developed—and have furthermore filed a PCT patent application for—“Method and device for manufacturing non-contaminated MOX fuel rods” in the name of the same applicant; this method and device allow industrial loading speeds (>100-150 mm/sec) compatible with high-capacity plants; this method and device make it possible to industrially produce non-contaminated MOX fuel rods.

It must be understood that the invention is in no way limited to the modes and embodiments described and that clearly modifications can be made thereto without departing from the scope of the claims.

The invention is in particular applicable to the manufacture of fuels based on uranium oxide, with or without burnable poison, as well as to new types of nuclear fuel based on actinides other than uranium (nitrides or carbides of uranium/plutonium, fuels with no fertile material intended for incinerating reactors or actinide transmuters, MOX based on thorium/plutonium, MOX with poison, burnable or not, etc.).

1. Method for loading nuclear fuel pellets (6) in successive columns (12) into a cladding (2) previously provided with a first plug (3) at one of its two ends, comprising the following associated operations:
presenting, centring and aligning the pellets (6) of a column (12) from a support (38) to the open end (34) of the cladding (2); and
characterised in that, for loading of the pellets (6), the following are performed:
correction of off-centrings between the support (38) and the open end (34) of the cladding (2), and alignment of the axis of the pellets (6) with the axis of the cladding (2), by means of a channel (42), the bottom of which has a V-shaped profile in a continuous ramp and intersecting with a cylindrical output (48) with the diameter of the pellets (6);
centring of the cladding (2) in a chamber (49) centred on the cylindrical output (48) of the channel (42);
masking of the open end (34) of the cladding (2) from the pellet (6) in the process of being loaded;
trapping and/or collection and/or forcing back of dust and chips conveyed by and/or adhering to the pellets (6) loaded, and/or generated by the presentation, centring and alignment operations, via the free sections between pellets (6) and walls of the channel (42) and/or via clearances, by gravity deposition and optionally by additional blowing and/or suction.

2. Method according to claim 1, characterised by loading of the pellets (6) of a column (12) into the cladding (2), to a depth of introduction of the last pellet (6) in the cladding (2) equal to at least the length of the next column (12) to be loaded into the same cladding (2).

3. Method according to claim 2, characterised in that loading of said pellets (6) in successive columns (12) into said cladding (2) is performed by limiting the maximum pushing forces during loading, according to the depth of introduction and the order (N) of the column (12) in the process of being loaded into the same cladding (2).

4. Method according to claim 1, characterised in that loading of the pellets (6) takes place either under vacuum in a cladding (2) itself under vacuum, or under helium, in a cladding (2) itself filled with helium.

5. Device for loading pellets (6) into a cladding (2), in particular for implementation of the method according to claim 1, characterised in that it comprises, for presentation, centring and alignment of the pellets (6) at the input of the cladding (2), a fixed introduction element (14)
consisting of a metal component (14) with a channel (42) passing through it, the dimensions of the input (44) of which are chosen for accepting an off-centring of the pellets (6) in relation to the axis of the cladding (2), and the bottom of which has a V-shaped profile in a continuous ramp and intersecting with a cylindrical output (48) with the diameter of the pellets (6), and provided with a cylindrical chamber (49) with the diameter of the cladding (2) and centred on the cylindrical output (48) of the channel (42);
has dimensions and tolerances adapted to the dimensions of said pellets (6) and cladding (2), and such that the diameter of the cylindrical part (48) of the channel (42) is smaller than the internal diameter of the cladding (2), for the purposes of masking the end (34) of the cladding (2) from the pellets (6);
optionally has longitudinal and/or transverse trapping clearances and/or nozzles for blowing a gas in a direction opposite to the direction of loading and/or sucking up the dust and chips.

6. Device according to claim 5, characterised in that it comprises, for the above-mentioned loading of the pellets (6), a long pushing device (50) with sensitive drive, having:
on the one hand axial driving by a set of rollers (56) equipped with a force limiting device (54) with low inertia and driven by a motor (52), the force of which is limited according to the depth of introduction and the order (N) of the column (12) of pellets (6) in the process of being loaded into one and the same cladding (2); and
on the other hand a hollow rod (53) of low mass and adapted length, so that the depth of introduction of the last pellet (6) of a column (12) loaded into the cladding (2) is equal to at least the length of the next column (12) to be loaded into the same cladding (2).

7. Method according to claim 2, characterised in that loading of the pellets (6) takes place either under vacuum in a cladding (2) itself under vacuum, or under helium, in a cladding (2) itself filled with helium.

8. Method according to claim 3, characterised in that loading of the pellets (6) takes place either under vacuum in a cladding (2) itself under vacuum, or under helium, in a cladding (2) itself filled with helium.
